(19) United States
(12) Patent Application Publication
(10) Pub. No.: US 2026/0099252 A1
(43) Pub. Date: Apr. 9, 2026

(54) SYSTEM AND METHOD FOR IN-NAND GARBAGE COLLECTION

(71) Applicant: SK hynix Inc., Gyeonggi-do (KR)

(72) Inventors: Pengfei HUANG, San Jose, CA (US); Fan ZHANG, San Jose, CA (US)

(21) Appl. No.: 18/905,625

(22) Filed: Oct. 3, 2024

(51) Int. Cl. G06F 3/06

(52) U.S. Cl. CPC G06F 3/0611; G06F 3/064; G06F 3/0679

(57) ABSTRACT

A method and memory device for performing a garbage collection operation. The memory device includes memory planes including first and second memory planes, each memory plane including memory blocks; and a processor including a checksum calculator to calculate checksum on valid page data of at least one victim block in the first memory plane. The processor is configured to: determine whether at least one target block in the first memory plane is open or full; determine whether the checksum is less than a checksum threshold; and selectively perform one of an internal garbage collection in the first memory plane and an external garbage collection outside the first memory plane, based on the determining whether the target block is open or full and the determining whether the checksum is less than the checksum threshold.

### BACKGROUND

### 1. Field

The present invention relates to a garbage collection operation in solid state drives.

### 2. Description of the Related Art

The computer environment paradigm has shifted to ubiquitous computing systems that can be used anytime and anywhere. As a result, the use of portable electronic devices such as mobile phones, digital cameras, and notebook computers has rapidly increased. These portable electronic devices generally use a memory system having memory device(s), that is, data storage device(s). The data storage device is used as a main memory device or an auxiliary memory device of the portable electronic devices. Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD).

The SSD may include flash memory components and a controller, which includes the electronics that bridge the flash memory components to the SSD input/output (I/O) interfaces. The SSD controller can include an embedded processor that can execute functional components such as firmware. The SSD functional components are device specific, and in most cases, can be updated. One type of flash memory components is named NAND after the NAND logic gates in this SSD. The NAND-type flash memory may be written and read in blocks (or pages) which are generally much smaller than the entire memory space. The NAND-type operates primarily in memory cards, USB flash drives, solid-state drives, and similar products, for general storage and transfer of data.

Memory systems such as NAND flash based memory systems may perform a background operation for a memory device such as a garbage collection (GC) operation, a wear leveling (WL) operation, a map flush operation, and/or a bad block management operation in order to efficiently use memory space of the memory device.

In this context, embodiments of the present invention for performing a garbage collection operation arise.

### SUMMARY

Embodiments of the present invention include a system and a method for performing a garbage collection operation capable of reducing transfer traffic between NAND and SoC and saving SSD power consumption.

In accordance with one embodiment of the present invention, there is provided a memory device. The memory device includes a plurality of memory planes including first and second memory planes, each memory plane including a plurality of memory blocks; and a processor including a checksum calculator to calculate checksum on valid page data of at least one victim block in the first memory plane. The processor is configured to: determine whether at least one target block in the first memory plane is open or full; determine whether the checksum is less than a checksum threshold; and selectively perform one of an internal garbage collection in the first memory plane and an external garbage collection outside the first memory plane, based on the determining whether the target block is open or full and the determining whether the checksum is less than the checksum threshold.

In accordance with another embodiment of the present invention, there is provided a method for operating a memory device, which includes a plurality of memory planes and a processor including a checksum calculator. The method includes determining whether at least one target block in a first memory plane among the plurality of memory planes is open or full; determining whether checksum on valid page data of at least one victim block calculated by the checksum calculator is less than a checksum threshold; and selectively performing one of an internal garbage collection in the first memory plane and an external garbage collection outside the first memory plane, based on the determining whether the target block is open or full and the determining whether the checksum is less than the checksum threshold.

### BRIEF DESCRIPTION OF THE DRAWINGS

FIG. 1 is a high level block diagram illustrating an error correcting system in accordance with embodiments of the present invention.

FIG. 2 is a block diagram schematically illustrating a memory system in accordance with embodiments of the present invention.

FIG. 3 is a block diagram illustrating a memory system in accordance with embodiments of the present invention.

FIG. 4 is a circuit diagram illustrating a memory block of a memory device in accordance with embodiments of the present invention.

FIG. 5 is a diagram illustrating a storage system in accordance with embodiments of the present invention which includes an in-NAND descrambler.

FIG. 6 is a diagram illustrating a format of a codeword to be stored in a storage system in accordance with embodiments of the present invention.

FIG. 7 is a depiction of a system on chip (SoC) and NAND where data to be descrambled is transferred to a descrambler of the SoC.

FIG. 8 is a diagram illustrating a concept of garbage collection operations in accordance with embodiments of the present invention.

FIG. 9 is a diagram illustrating an inner plane transfer requirement of an internal garbage collection operation in accordance with embodiments of the present invention.

FIG. 10 is a diagram illustrating an example of an internal garbage collection operation in accordance with an embodiment of the present invention.

FIG. 11 is a diagram illustrating a data striping operation in accordance with an embodiment of the present invention.

FIG. 12 is a diagram illustrating a data program operation based on a data striping operation in accordance with an embodiment of the present invention.

FIG. 13 is a diagram illustrating an example of a data striping based internal garbage collection operation in accordance with an embodiment of the present invention.

FIG. 14 is a flow chart illustrating a method for calculating checksums on scrambled data read from a storage of a memory system according to another embodiment of the present invention.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will convey the scope of the present invention to those skilled in the art. Throughout the disclosure, like reference numerals refer to like parts throughout the various figures and embodiments of the present invention.

The invention can be implemented in numerous ways, including as a process; an apparatus; a system; a composition of matter; a computer program product embodied on a computer readable storage medium; and/or a processor, such as a processor suitable for executing instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being suitable for performing a task may be implemented as a general component that is temporarily suitable for performing the task at a given time or a specific component that is manufactured to perform the task. As used herein, the term ‘processor’ refers to one or more devices, circuits, and/or processing cores suitable for processing data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention encompasses numerous alternatives, modifications and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

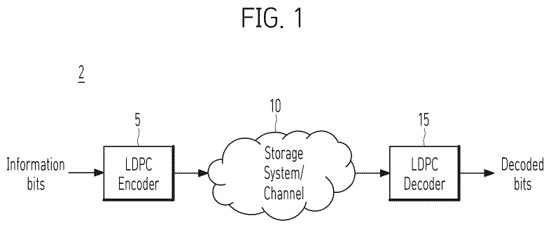

FIG. 1 is a high-level block diagram illustrating an error correcting system 2, in accordance with embodiments of the present invention. More specifically, the high-level block diagram in FIG. 1 shows error correcting system 2 including an encoder 5 and a decoder 15 using for example LDPC coding and decoding algorithms. That is, error correcting system 2 may include a LDPC encoder 5 and a LDPC decoder 15, although other coding and decoding algorithms can be used.

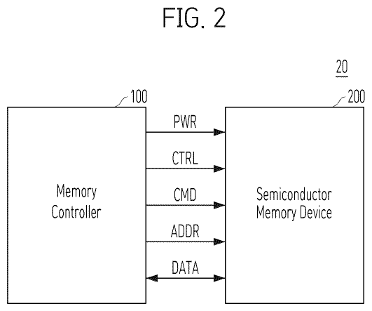

The LDPC encoder 5 may receive information bits including data which is desired to be stored in a storage system 10 (such as in memory system 20 of FIG. 2). The LDPC encoder 5 may encode the information bits to output LDPC encoded data. The LDPC encoded data from the LDPC encoder 5 may be written to a storage device or memory device of the storage system 10. In various embodiments, the storage device may include a variety of storage types or media. In some embodiments, during being written to or read from the storage device, data is transmitted and received over a wired and/or wireless channel. In this case, the errors in the received codeword may be introduced during transmission of the codeword.

When the stored data in the storage system 10 is requested or otherwise desired (e.g., by an application or user which stored the data), the LDPC decoder 15 may perform LDPC decoding of data received from the storage system 10, which may include some noise or errors. In various embodiments, the LDPC decoder 15 may perform LDPC decoding using the decision and/or reliability information for the received data. The decoded bits generated by the LDPC decoder 15 are transmitted to the appropriate entity (e.g., the user or application which requested it). With proper encoding and decoding, the information bits match the decoded bits.

When the stored data in storage system 10 is requested or otherwise desired (e.g., by an application or user which stored the data), the LDPC decoder 15 may receive data from the storage system 10. The received data may include some noise or errors. The LDPC decoder 15 may perform detection on the received data and output decision and/or reliability information. The LDPC decoder 15 may include one of a soft detector and a hard detector. Either the soft detector or the hard detector can provide channel information for decoders, such as the LDPC decoder. For example, the soft detector may output reliability information and a decision for each detected bit. On the other hand, the hard detector may output a hard decision on each bit without providing corresponding reliability information. As an example, the hard detector may output as the hard decision that a particular bit is a “1” or a “0” without indicating how certain or sure the detector is in that decision. In contrast, the soft detector may output a decision and reliability information associated with the decision. In general, reliability information indicates how certain the detector is in a given decision. In one example, a soft detector may output a log-likelihood ratio (LLR) where the sign indicates the decision (e.g., a positive value corresponds to a “1” decision and a negative value corresponds to a “0” decision) and the magnitude indicates how sure or certain the detector is in that decision (e.g., a large magnitude indicates a high reliability or certainty).

LDPC decoder 15 may perform LDPC decoding using the decision and/or reliability information. The decoded bits generated by the LDPC decoder 15 can be transmitted to the appropriate entity (e.g., the user or application which requested it). With proper encoding and decoding, the information bits match the decoded bits.

In LDPC decoding, a syndrome update may check to see if all of the errors have been removed from a codeword containing user data or bit data. For example, if for the parity check matrix H, the LDPC checksum ĉH=0, then the syndrome update can determine that decoding is successful and all errors have been removed from the codeword. If so, the LDPC decoding stops decoding and outputs ĉ=[ĉ1, ĉ2, . . . ĉN] as the decoded output.

If the LDPC checksum is not equal to zero, the decoded codeword (i.e., ĉ) is not output and another decoding iteration is performed until a maximum number of iterations, which may be predefined, is reached. In other words, a variable node update calculates new variable to check node (V2C) messages and new log likelihood ratios (LLR) values, the check node update calculates new check to variable node (C2V) messages, and the codeword update calculates a new codeword and checks if the product of the new codeword and the parity check matrix is 0, that is ĉH=0.

If a correct codeword is not found, the iterations continue with another update from the variable nodes using the messages that they received from the check nodes to decide if the bit at their position should be a zero or a one by a majority rule. The variable nodes then send this hard decision message to the check nodes that are connected to them. The iterations continue until a correct codeword is found.

In some embodiments, an LDPC decoding operation may be performed according to bit flipping decoding. In bit-flipping decoders, the decoder may process a fixed number W of variable nodes (VN) in one clock-cycle. That is for each of the VNs to be processed in a cycle, the decoder counts the number of neighboring check nodes (CN) that are unsatisfied and compares this number with a threshold T. If the count is larger than the threshold T, the decoder flips the current bit-value of the VN. The variable nodes are typically each processed one-by-one from the first variable node to the last variable node.

FIG. 2 is a block diagram schematically illustrating a memory system 20 in accordance with one embodiment of the present invention.

Referring FIG. 2, the memory system 20 may include a memory controller 100 and a semiconductor memory device 200.

The memory controller 100 may control overall operations of the semiconductor memory device 200.

The semiconductor memory device 200 may perform one or more erase, program, and read operations under the control of the memory controller 100. The semiconductor memory device 200 may receive a command CMD, an address ADDR and data DATA through input/output lines. The semiconductor memory device 200 may receive power PWR through a power line and a control signal CTRL through a control line. The control signal may include a command latch enable (CLE) signal, an address latch enable (ALE) signal, a chip enable (CE) signal, a write enable (WE) signal, a read enable (RE) signal, and so on.

The memory controller 100 and the semiconductor memory device 200 may be integrated in a single semiconductor device. For example, the memory controller 100 and the semiconductor memory device 200 may be integrated in a single semiconductor device such as a solid state drive (SSD). The solid state drive may include a storage device such as a NAND memory for storing data therein.

The memory controller 100 and the semiconductor memory device 200 may be integrated in a single semiconductor device such as a memory card. For example, the memory controller 100 and the semiconductor memory device 200 may be integrated in a single semiconductor device configured to have a memory card such as a PC card of personal computer memory card international association (PCMCIA), a compact flash (CF) card, a smart media (SM) card, a memory stick, a multimedia card (MMC), a reduced-size multimedia card (RS-MMC), a micro-size version of MMC (MMCmicro), a secure digital (SD) card, a mini secure digital (miniSD) card, a micro secure digital (microSD) card, a secure digital high capacity (SDHC), or a universal flash storage (UFS).

In another example, the memory system 20 may be provided as one of various elements including an electronic device such as a computer, an ultra-mobile PC (UMPC), a workstation, a net-book computer, a personal digital assistant (PDA), a portable computer, a web tablet PC, a wireless phone, a mobile phone, a smart phone, an e-book reader, a portable multimedia player (PMP), a portable game device, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage device of a data center, a device capable of receiving and transmitting information in a wireless environment, one of electronic devices of a home network, one of electronic devices of a computer network, one of electronic devices of a telematics network, a radio-frequency identification (RFID) device, or elements devices of a computing system.

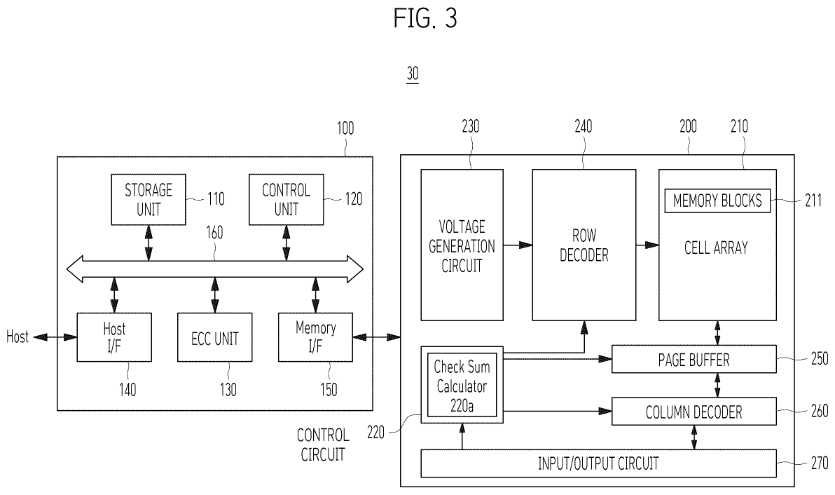

FIG. 3 is a detailed block diagram illustrating various embodiments of memory system 30. For example, memory system 30 of FIG. 3 may depict the storage system 10 shown in FIG. 1 or the memory system 20 shown in FIG. 2.

Referring to FIG. 3, the memory system 30 may include the memory controller 100 and the semiconductor memory device 200. The memory system 30 may operate in response to a request from a host device, and in particular, store data to be accessed by the host device.

The host device may be implemented with any one of various kinds of electronic devices. In some embodiments, the host device may include an electronic device such as a desktop computer, a workstation, a three-dimensional (3D) television, a smart television, a digital audio recorder, a digital audio player, a digital picture recorder, a digital picture player, a digital video recorder or a digital video player. In some embodiments, the host device may include a portable electronic device such as a mobile phone, a smart phone, an e-book, an MP3 player, a portable multimedia player (PMP), or a portable game player.

The memory device 200 may store data to be accessed by the host device.

The memory device 200 may be implemented with various memory devices such a NAND flash memory, which is particularly advantageous, but the present invention is not so limited and other volatile and non-volatile memory devices may be used such as for example a dynamic random access memory (DRAM) and a static random access memory (SRAM), a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM (RRAM).

The controller 100 may control storage of data in the memory device 200. For example, the controller 100 may control the memory device 200 in response to a request from the host. The controller 100 may provide the data read from the memory device 200, to the host, and store the data provided from the host into the memory device 200. In one embodiment, especially for NAND flash based memory systems, controller 100 may include a scrambler for scrambling data, which is to be written to the memory device 200, and a descrambler for descrambling data, which is read from the memory device 200.

The controller 100 may include a storage unit 110, a control unit 120, the error correction code (ECC) unit 130, a host interface 140 and a memory interface 150, which are coupled through a bus 160.

The storage unit 110 may serve as a working memory of the memory system 10 and the controller 100, and store data for driving the memory system 10 and the controller 100. When the controller 100 controls operations of the memory device 200, the storage unit 110 may store data used by the controller 100 and the memory device 200 for such operations as read, write, program and erase operations.

The storage unit 110 may be implemented with a volatile memory. The storage unit 110 may be implemented with a static random access memory (SRAM) or a dynamic random access memory (DRAM). As described above, the storage unit 110 may store data used by the host device in the memory device 200 for the read and write operations. To store the data, the storage unit 110 may include a program memory, a data memory, a write buffer, a read buffer, a map buffer, and so forth.

Referring to FIG. 3, the control unit 120 may control general operations of the memory system 30, and a write operation or a read operation for the memory device 200, in response to a write request or a read request from the host device. The control unit 120 may drive firmware, which is referred to as a flash translation layer (FTL), to control the general operations of the memory system 10. For example, the FTL may perform operations such as logical to physical (L2P) mapping, wear leveling, garbage collection, and bad block handling. The L2P mapping is known as logical block addressing (LBA).

The ECC unit 130 may detect and correct errors in the data read from the memory device 200 during the read operation. The ECC unit 130 may not correct error bits when the number of the error bits is greater than or equal to a threshold number of correctable error bits, and may output an error correction fail signal indicating failure in correcting the error bits.

In some embodiments, the ECC unit 130 may perform an error correction operation based on a coded modulation such as an LDPC code, a Bose-Chaudhuri-Hocquenghem (BCH) code, a turbo code, a turbo product code (TPC), a Reed-Solomon (RS) code, a convolution code, a recursive systematic code (RSC), a trellis-coded modulation (TCM), a Block coded modulation (BCM), and so on. The ECC unit 130 may include all circuits, systems or devices for the error correction operation.

As shown in FIG. 3, host interface 140 may communicate with the host device through one or more of various interface protocols such as a universal serial bus (USB), a multi-media card (MMC), a peripheral component interconnect express (PCI-e or PCIe), a small computer system interface (SCSI), a serial-attached SCSI (SAS), a serial advanced technology attachment (SATA), a parallel advanced technology attachment (PATA), an enhanced small disk interface (ESDI), or an integrated drive electronics (IDE).

The memory interface 150 may provide an interface between the controller 100 and the memory device 200 to allow the controller 100 to control the memory device 200 in response to a request from the host device. The memory interface 150 may generate control signals for the memory device 200 and process data under the control of the control unit (e.g., CPU) 120. When the memory device 200 is a flash memory such as a NAND flash memory, the memory interface 150 may generate control signals for the memory and process data under the control of the control unit 120.

The memory device 200 may include a memory cell array 210, a control circuit 220, a voltage generation circuit 230, a row decoder 240, a page buffer 250, a column decoder 260, and an input/output circuit 270. The memory cell array 210 may include a plurality of memory blocks 211 and may store data therein. The control circuit 220 includes in one embodiment of the present invention checksum calculator module 220a (described in more detail below). The voltage generation circuit 230, the row decoder 240, the page buffer 250, the column decoder 260 and the input/output circuit 270 form a peripheral circuit for the memory cell array 210. The peripheral circuit may perform a program, read, or erase operation of the memory cell array 210. The control circuit 220 may control the peripheral circuit.

The voltage generation circuit 230 may generate operation voltages having various levels. For example, in an erase operation, the voltage generation circuit 230 may generate operation voltages having various levels such as an erase voltage and a pass voltage.

The row decoder 240 may be connected to the voltage generation circuit 230, and the plurality of memory blocks 211. The row decoder 240 may select at least one memory block among the plurality of memory blocks 211 in response to a row address RADD generated by the control circuit 220, and transmit operation voltages supplied from the voltage generation circuit 230 to the selected memory blocks among the plurality of memory blocks 211.

The page buffer 250 may be connected to the memory cell array 210 through bit lines BL. The page buffer 250 may precharge the bit lines BL with a positive voltage, transmit/receive data to/from a selected memory block in program and read operations, or temporarily store transmitted data, in response to a page buffer control signal generated by the control circuit 220.

The column decoder 260 may transmit/receive data to/from the page buffer 250 or transmit/receive data to/from the input/output circuit 270.

The input/output circuit 270 may transmit, to the control circuit 220, a command and an address, transmitted from an external device (e.g., the memory controller 100), transmit data from the external device to the column decoder 260, or output data from the column decoder 260 to the external device, through the input/output circuit 270. The control circuit 220 may control the peripheral circuit in response to the command and the address.

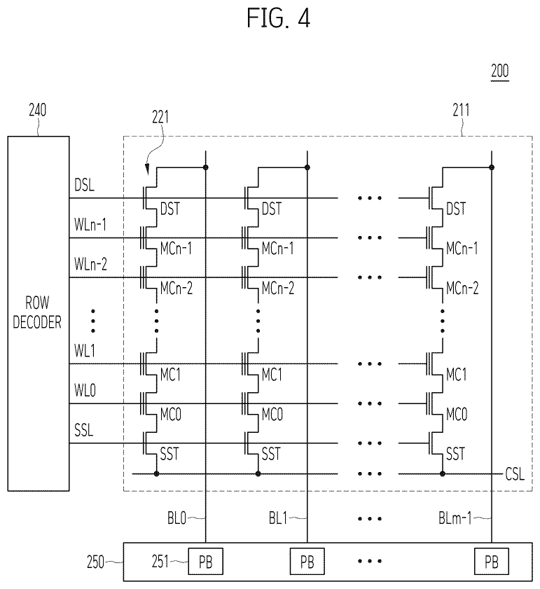

FIG. 4 is a circuit diagram illustrating a memory block of a semiconductor memory device in accordance with an embodiment of the present invention. For example, a memory block of FIG. 4 may be the memory blocks 211 of the memory cell array 210 shown in FIG. 3.

Referring to FIG. 4, the memory blocks 211 may include a plurality of cell strings 221 coupled to bit lines BL0 to BLm−1, respectively. The cell string of each column may include one or more drain selection transistors DST and one or more source selection transistors SST. A plurality of memory cells or memory cell transistors may be serially coupled between the selection transistors DST and SST. Each of the memory cells MC0 to MCn−1 may be formed of a multi-level cell (MLC) storing data information of multiple bits in each cell. The cell strings 221 may be electrically coupled to the corresponding bit lines BL0 to BLm−1, respectively.

The page buffer 250 may include a plurality of separate page buffers PB 251 that are coupled to the bit lines BL0 to BLm−1. The page buffers PB 251 may operate in response to page buffer control signals. For example, the page buffers PB 251 may temporarily store data received through the bit lines BL0 to BLm−1 or sense voltages or currents of the bit lines during a read or verify operation.

### Checksum Calculator

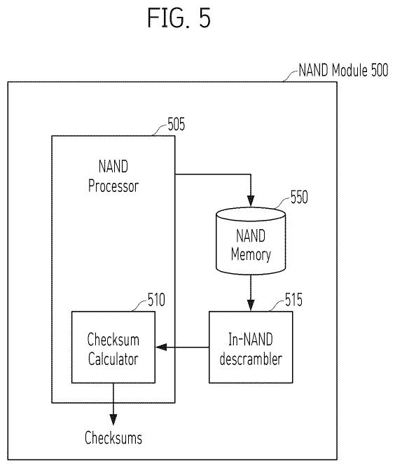

FIG. 5 is a diagram illustrating a storage system in accordance with embodiments of the present invention where the NAND module 500 shown in FIG. 5 uses NAND memory 550 which may correspond to memory device 200 in FIG. 3.

Referring to FIG. 5, the NAND module 500 may include NAND memory 550 as storage and includes therein NAND processor 505. The NAND processor 505 may perform a read operation on data in NAND memory 550. During the read operation, the data needs to be descrambled to be in the correct format for computing checksum. Then, the checksum calculator is able to compute a checksum in order to estimate RBER. As noted above, when the number of the error bits is greater than or equal to a threshold number of correctable error bits, an error correction fail signal may be output, which indicates failure in correcting the error bits. Such failure may require that the information bits from a host will need to be sent again to NAND memory 550. Accordingly, checksum calculator 510 can be used to provide an estimate of the RBER in data to be stored in NAND memory 550. In one embodiment of the present invention, an In-NAND descrambler 515 is provide such that scrambled data read from NAND memory 550 may be descrambled prior to the read data being supplied to checksum calculator 510.

In various embodiments, the NAND Module 500 shown in FIG. 5 may be implemented using a variety of techniques including an application-specific integrated circuit (ASIC), a field-programmable gate array (FPGA), and/or a general purpose processor (e.g., an Advanced RISC Machine (ARM) core).

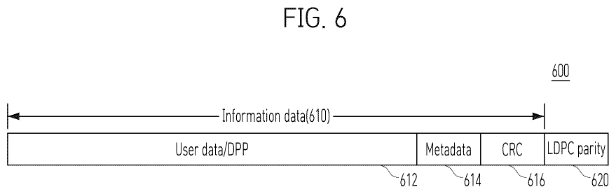

As background, FIG. 6 is a diagram illustrating a format of a codeword 600 to be stored in a storage system. Referring to FIG. 6, the codeword 600 may include information data 610 (information bits or user data) and LDPC parity data 620. In some embodiments, the codeword 600 may be generated by the LDPC codes noted above.

The information data 610 may include user data with data path protection (DPP) 612, meta-data 614 and cyclic redundancy check (CRC) parity bits 616. A CRC code which is an error-detecting code commonly used in digital networks and storage devices may detect accidental changes to raw data.

In a typical LDPC decoder, if the LDPC checksum is zero, the decoding may be terminated. The CRC parity bits 616 will be computed based on the decoded user data 612 and meta-data 614 after the LDPC decoding. If the computed CRC parity bits match the decoded CRC parity bits, decoding may be successful. Otherwise, a mis-correction may be declared.

As more background, in SSD applications, non-host read requests from SOC (e.g., from control unit 12 in memory controller 100 of FIG. 3) can reduce the quality of service (QoS) and power. Referring back to FIG. 3, when the tasks of transferring non-host data to the SOC are performed, a substantial amount of data needs to be transferred between memory cell array 210 of the semiconductor memory device 200 and control unit 120 which causes a power drop. To reduce this power and performance (e.g., QoS) drop, one embodiment of the present invention avoids transferring, to the SOC, non-host data associated with non-host read request from a memory device (e.g., NAND module 500 of FIG. 5). This can be done by estimating RBER in NAND module, and only transferring the non-host reads when the RBER is large.

In order to run these tasks more efficiently, in one embodiment of the present invention, the semiconductor memory device 200 (in FIG. 3) or NAND module 500 (in FIG. 5) may measure the checksum to estimate the number of errors in the stored data. Such an in-NAND module calculating the RBER can improve the performance/power of SSD by eliminating the need to transfer the stored data to the SOC when the RBER is acceptable.

As shown in FIG. 5, in one embodiment of the present invention there is provided checksum calculator 510 inside NAND module 500. The in-NAND module 500 can be a processor with a minimum silicon area (gate count) and can calculate a checksum using the methods described herein.

As described in U.S. Pat. No. 11,502,703 (the entire contents of which are incorporated by reference), since programming data “as is” tends to decrease endurance (e.g., lifespan) or reliability of a memory system, a scrambler (or randomizer) randomizes data such that data is uniformly and more reliably programmed to a memory device. With reference to FIG. 3, data from a host may be scrambled by memory controller 100 to scramble the information bits in a codeword. The scrambled data having the scrambled information bits is passed to memory blocks 211. Subsequently, data read from memory blocks 211 cannot be directly used for calculating checksum (CS), and will need to be descrambled before a checksum calculation can be performed to determine if the unscrambled data has an acceptable RBER reflected by the checksum calculated.

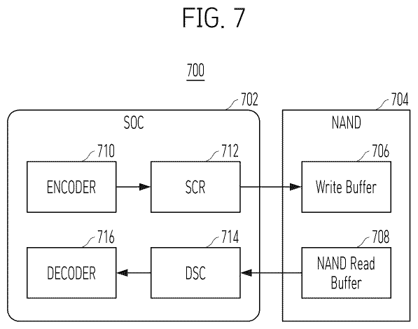

FIG. 7 depicts a block diagram of a memory system 700 having a SoC 702 and a NAND memory device 704 having write buffer 706 and read buffer 708. FIG. 7 depicts write/read channels operated with an ESN (Encoder-Scrambler-NAND) order. In the top channel depicted in FIG. 7, host write data first is encoded (e.g., in ECC unit 130 in memory controller 100), then the LDPC code (encoded data) generated by encoder 710 is scrambled by scrambler (SCR) 712 before being stored in memory device 704 or write buffer 706. During a read process, in the lower channel, data from NAND read buffer 708 is descrambled by descrambler (DSC) 714, and then the host data is recovered in decoder 716. In this system, as noted above, the data stored in NAND read buffer 708 is scrambled data and cannot be directly used for calculating CS.

In one embodiment of the present invention, an in-NAND checksum calculator using quasi-cyclic (QC) LDPC codes can handle scrambled read data using in-NAND descrambler 515 (noted above) along with in-NAND CS calculation scheme for QC LDPC codes. Details of the in-NAND CS calculation scheme are described in U.S. patent application Ser. No. 18/810,382 filed on Aug. 20, 2024, entitled “Method and System for In-NAND Checksum Calculating for Scrambled NAND Data”, the entire contents of which are incorporated by reference.

In a memory system as described above, a background operation such as a garbage collection may be performed in order to more efficiently use memory space therein. The garbage collection operation refers to an operation of periodically changing an invalidated page to an empty page. In the example of FIG. 7, a normal NAND garbage collection (GC) works as follows: first valid page data of a victim block is transferred out from NAND 704 to external SoC 702 (i.e., decoder 716), and then the decoded data is written back to NAND 704. Normal NAND garbage collection causes a lot of transfer traffic between NAND 704 and SoC 702 and a lot of SSD power consumption. Accordingly, embodiments of the present invention provide a garbage collection scheme capable of reducing the transfer traffic between a memory device (e.g., NAND 704) and a controller (e.g., SoC 702) and thereby saving power consumption of a memory system or a storage device (e.g., SSD).

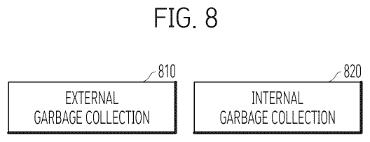

FIG. 8 is a diagram illustrating a concept of garbage collection operations in accordance with embodiments of the present invention.

Referring to FIG. 8, a memory system of embodiments of the present invention may perform an external garbage collection (EGC) 810 and an internal garbage collection (IGC) 820. The external garbage collection in this disclosure includes the normal NAND garbage collection described above with the transfer of valid page data from a victim block from NAND 704 to SoC 702. Furthermore, the external garbage collection in this disclosure includes the transfer of valid page data from a victim block from a first memory plane to a target block of a second memory plane. The internal garbage collection described above without the transfer of valid page data from NAND 704 to SoC 702 is performed if a particular condition is satisfied e.g., if a target block in the NAND for transfer of valid data to is open and/or if a checksum on a block subject to garbage collection (a victim block) is less than a checksum threshold.

### In-NAND Partial Check-Sum (PCS)

In U.S. patent application Ser. No. 18/810,382, the partial checksum was streamline computed using an in-NAND processor (e.g., NAND module 500 of FIG. 5) during sensing and data transfer between internal buffers. PCS can be used to estimate the underlying FBC. In general, when PCS is low, data is considered to be clean. When PCS is high, the data is considered to be noisy and needs to be sent out to an external decoder (e.g., decoder 716 of FIG. 7).

Referring back to FIG. 5, the NAND processor 505 can decide if a page has low fail bit count (FBC) using an in-NAND partial check-sum calculated by the checksum calculator 510 in the NAND module 500. When the PCS of a page is low, which indicates a low FBC, the internal garbage collection can be conducted; that is, the valid page data can be directly transferred to a target block in NAND without transferring data from NAND to external SoC/decoder. This can reduce transfer traffic between NAND and SoC and save SSD power consumption.

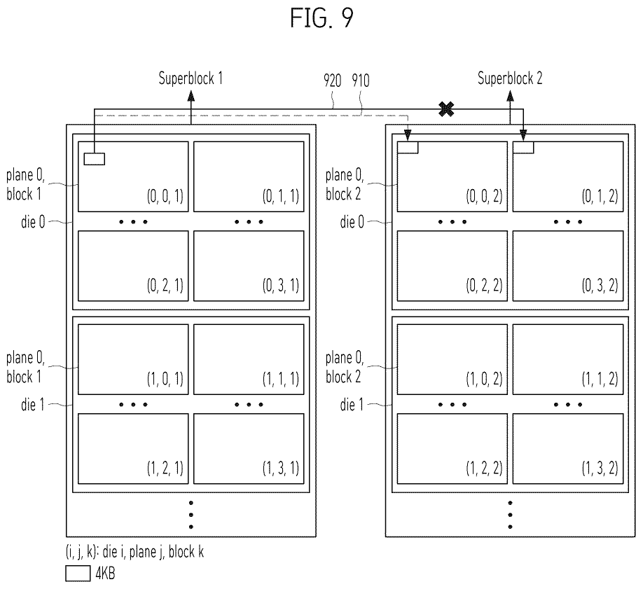

To reduce the in-NAND traffic collision and also simplify the scheduling, for internal garbage collection, it is preferred (but not necessary) that the data transfer only happens between blocks from the same die and same plane. In the illustrated example of FIG. 9, data of block 1 in plane 0 of die 0 (i.e., (die 0, plane 0, block 1)) can be transferred (910) or may only be transferred to another block (e.g., block 2) in plane 0 of die 0 (i.e., (0, 0, 2)), but may not be transferred out (920) to block 2 in plane 1 of die 0 (i.e., (0, 1, 2)). In contrast, for external garbage collection, no such restriction exists, and data can be transferred across different dies and planes. That is, in accordance with embodiments of the present invention. the internal garbage collection represents data transfer within the plane. In the illustrated example of FIG. 9 without limitation, each of first and second superblocks includes a plurality of dies (e.g., die 0, die 1, . . . ), each die includes a plurality of planes (e.g., 4 planes), each plane includes a block (e.g., block 1). The first superblock may be a victim superblock, while the second superblock may be a target superblock. For example, the valid page data may be 4 KB data. The operation of FIG. 9 may be performed by the control circuit 220 of FIG. 3 or the NAND processor 505 of FIG. 5. The superblocks of FIG. 9 may be generated from the memory cell array 210 of FIG. 3 or the NAND memory 550 of FIG. 5.

To achieve this inner plane data transfer requirement of IGC, embodiments of the present invention provide two schemes: first scheme A) an “opportunistic” internal garbage collection, and second scheme B) a data striping based internal garbage collection.

According to the first scheme, when the target block in a plane is not full, an internal garbage collection is performed. Once the target block on the plane becomes full, the internal garbage collection is stopped, and external garbage collection proceeds. Thus, data can be transferred to open blocks in other planes to help close (or fill) the corresponding open superblock.

According to the second scheme, when a page becomes invalid, every block of a superblock has the same amount of invalid data. As a result, during the internal garbage collection, each block of the target superblock can be filled equally to reach closure of the target superblock at the same time.

The first and second schemes are described below.

### Scheme A: Opportunistic Internal Garbage Collection

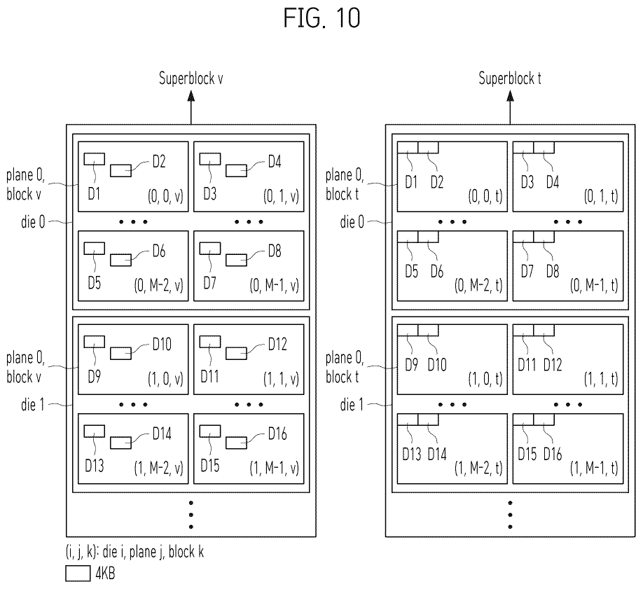

FIG. 10 is a diagram illustrating an example of an internal garbage collection operation in accordance with an embodiment of the present invention. The operation of FIG. 10 may be performed on the superblocks under control of the control circuit 220 of FIG. 3 or the NAND processor 505 of FIG. 5.

In the illustrated example of FIG. 10, a victim superblock (SB) v across N dies is illustrated. Each die includes M planes, and each plane includes victim blocks. Block (i, j, v) represents the block associated with SB v in die i and plane j. Also, a target superblock (SB) t and its associated blocks (i, j, t) in die i and plane j are illustrated. The superblocks of FIG. 10 may be generated from the memory cell array 210 of FIG. 3 or the NAND memory 550 of FIG. 5. The garbage collection of valid page data from the victim superblock v to the target superblock t works as shown in List 1:

List 1:

```
  For block (i, j, v) of SB v:
  If block (i, j, t) of SB t is not full (i.e., open):
      If valid page PCS < TH_PCS
        Internal garbage transfers the valid page data to block
    (i, j, t)
      Else If valid page PCS >= TH_PCS
        External garbage transfers the valid page data to the
    least filled block in superblock SB t
      End
  Else If block (i, j, t) of SB t is full (i.e., closed):
      External garbage transfers the valid page data to the least filled
    block in superblock SB t
  End
End
```

Referring to List 1, the internal garbage collection is performed when a particular condition satisfies, e.g., a target block (i, j, t) is open (i.e., not full) and a partial checksum is less than a predetermined checksum threshold TH_PCS. That is, each block (i, j, v) of the victim superblock v performs internal garbage collection to transfer valid page data to the corresponding inner plane target block (i, j, t) of the target superblock t. In this embodiment, the transfer traffic of the internal garbage collection only exists in the same plane. That is, the internal garbage collection is performed to move the valid page data of the victim block in a first memory plane into the target block in the first memory plane. As shown in FIG. 10, the victim block is included in the victim superblock t, and the target block is included in the target superblock t. In this embodiment, the victim superblock v and the target superblock t (i.e., an inner target superblock t) are included in the same memory plane. Each of the victim superblock v and the inner target superblock t includes one or more memory blocks of the first memory plane.

When the target block (i, j, t) is open (i.e., not full) and the partial checksum is greater than or equal to the check threshold TH_PCS, external garbage collection may be performed. Further, when the target block (i, j, t) is full (i.e., closed), external garbage collection may be performed. The valid page data will be transferred to fill other open blocks of the target superblock t. That is, external garbage collection may be performed to move the valid page data of the victim block in a first memory plane into an open block (i.e., external open block) in a second memory plane. The external open block may be included in an external target superblock including one or more memory blocks of the second memory plane. For example, the first memory plane and the second memory plane may belong to a same memory die. For another example, the first memory plane and the second memory plane may belong to a different memory die. The external garbage collection helps to close the target superblock SB t in time. It is noted that the external garbage collection allows data transfer across dies and planes. In one example of the external garbage collection, data transfer may be performed to a target die different from a victim die. In another example of the external garbage collection, data transfer may be performed to a target plane different from a victim plane.

As such, the first scheme needs to switch between the internal garbage collection and the external garbage collection modes to opportunistically exploit the benefits of the internal garbage collection.

### Scheme B: Data Striping Based Internal Garbage Collection

This scheme provides a special data striping. With this striping, the internal garbage collection can close the target superblock.

### Data Striping

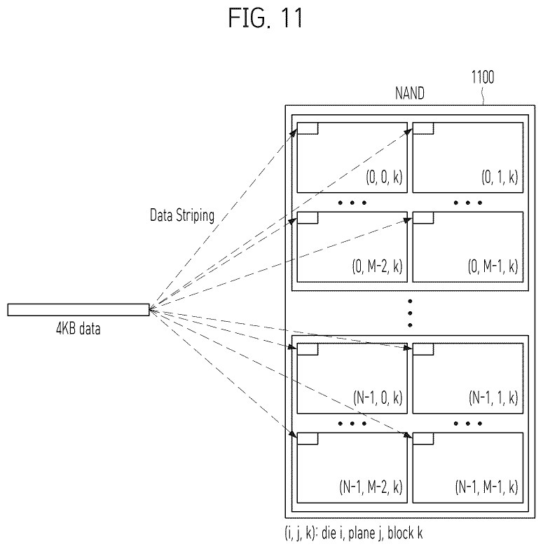

FIG. 11 is a diagram illustrating a data striping operation in accordance with embodiments of the present invention.

In the illustrated example of FIG. 11, NAND 1100 may include N dies and M planes per die. Every unit data (e.g., a 4 KB data unit) can be split equally into N*M data parts (or data entries); each data part of 4 KB/(N*M). Each data part (entry) can be distributed to each block of each plane, as shown in FIG. 11. The operation of FIG. 11 may be performed on superblocks under control of the control circuit 220 of FIG. 3 or the NAND processor 505 of FIG. 5.

### Program Data Accumulation

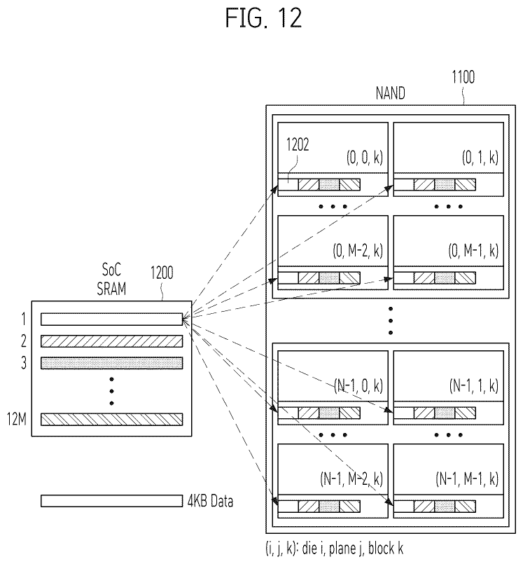

FIG. 12 is a diagram illustrating a data program operation based on a data striping operation in accordance with embodiments of the present invention.

Referring to FIG. 12, a memory (e.g., SRAM) of SoC 1200 stores data from a host (i.e., host data). In one example of a triple level cell (TLC) SSD, the SRAM has a size of 16 KB*3*M, which consists of 12*M*4 KB pages 1202.

As shown in FIG. 12, data of the SRAM of SoC 1200 is received and then stored in NAND 110. That is, each 4 KB page 1202 in SRAM of SoC is divided and distributed to a program buffer of NAND on each plane. For example, the program buffer may be the write buffer 706 in FIG. 7. Once the program buffer of NAND accumulates enough data (i.e., 16 KB*3), the programming is issued according to the data striping operation shown in FIG. 12. In this case, the SRAM size of SoC does not need to increase. This data striping operation may be performed on the superblocks under control of the control circuit 220 of FIG. 3 or the NAND processor 505 of FIG. 5.

### Internal Garbage Collection

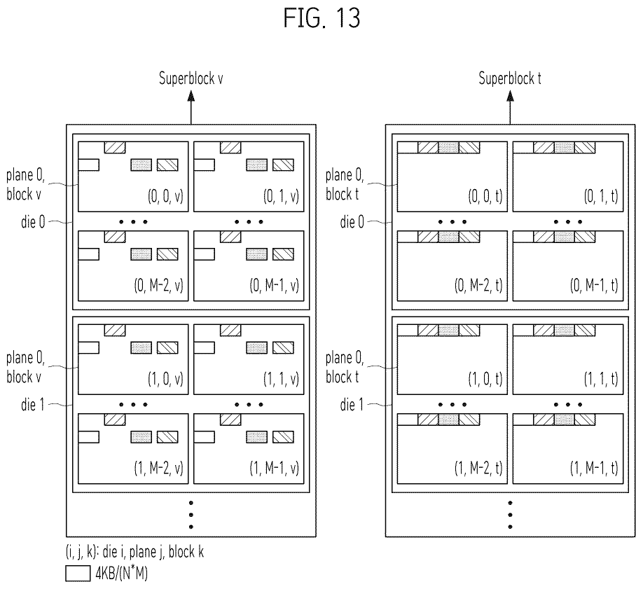

FIG. 13 is a diagram illustrating an example of a data striping based internal garbage collection operation in accordance with embodiments of the present invention.

In the illustrated example of FIG. 13, a victim superblock (SB) v across N dies is illustrated. Each die includes M planes, and each plane includes victim blocks. Block (i, j, v) represents the block associated with SB v in die i and plane j. Also, a target superblock (SB) t and its associated blocks (i, j, t) in die i and plane j are illustrated.

With the data striping, the internal garbage collection is straightforward. During the garbage collection, for a valid page in the victim superblock v (with the valid data having been distributed over all the blocks), if the PCS is less than a threshold TH_PCS, then the valid page data is moved to the target superblock t. For example, the processor 505 receives unit data from a memory controller (e.g., SoC 1200 of FIG. 12), splits the unit data to generate multiple data entries corresponding to memory blocks of the victim superblock v, and evenly stores the multiple data entries in the memory blocks as the victim block of the victim superblock v (as shown in victim superblock v). Then, as shown in FIG. 13 for target superblock t, valid page data entries stored in victim blocks of the victim superblock v are moved to corresponding target blocks the target superblock t and equally programmed into the blocks of target superblock t.

Since the data is programmed equally to all the blocks in the target superblock t (that the data is programmed into the same data positions in all the blocks of the target superblock), all the blocks of the target superblock t can be closed simultaneously. For example, the processor 505 receives unit data from a memory controller, splits the unit data to generate multiple data entries corresponding to memory blocks of the victim superblock, evenly stores the multiple data entries in the memory blocks as the victim block of the victim superblock, and thereafter transfers the valid data equally into all the blocks of the target superblock.

As such, the second scheme needs a special data striping. With this data striping, the data programming procedure needs some modification as shown in FIG. 12, but the internal garbage collection is straightforward and can close the target superblock when full.

### Computerized Method

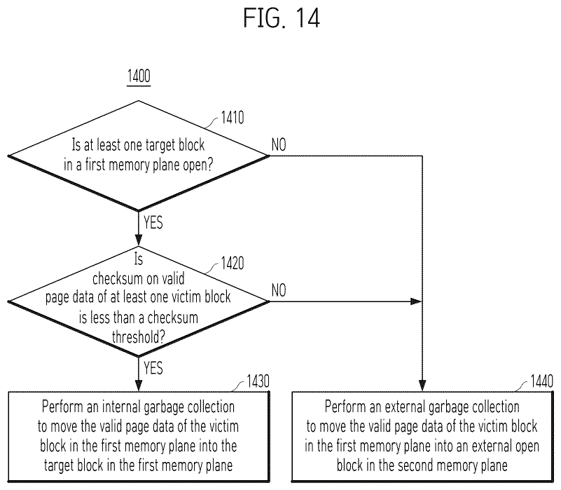

In one embodiment of the present invention, there is provided a method 1400 in FIG. 14 for performing garbage collection operation on a plurality of memory planes of a memory device. This method 1400 may be implemented a processor including a checksum calculator, e.g., the NAND processor 505 of FIG. 5.

Referring to FIG. 14, the method 1400 includes, at 1410, determining whether at least one target block in a first memory plane among the plurality of memory planes is open or not full. The method includes determining (1420) whether checksum on valid page data of at least one victim block calculated by the checksum calculator is less than a checksum threshold. The method 1400 includes selectively performing one of an internal garbage collection in the first memory plane and an external garbage collection outside the first memory plane, based on the determining whether the target block is open or full and the determining whether the checksum is less than the checksum threshold.

When it is determined that the target block is open (1410, YES) and the calculated checksum is less than the checksum threshold (1420, YES), the method 1400 includes performing (1430) the internal garbage collection to move the valid page data of the victim block in the first memory plane into the target block in the first memory plane.

In some embodiments, the victim block is included in a victim superblock, and the target block is included in an inner target superblock. Each of the victim superblock and the inner target superblock includes one or more memory blocks of the first memory plane.

In some embodiments, the method further comprises: receiving unit data from a memory controller, splitting the unit data to generate multiple data entries corresponding to memory blocks of the victim superblock, and evenly storing the multiple data entries in the memory blocks as the victim block of the victim superblock.

In some embodiments, the valid page data includes the multiple data entries. The method includes: performing the internal garbage collection to move the multiple data entries into the target block in the first memory plane.

When it is determined that the target block is full (1410, NO), the method 1400 includes performing (1440) the external garbage collection to move the valid page data of the victim block in the first memory plane into an external open block in the second memory plane.

When it is determined that the target block is open (1410, YES) and the calculated checksum is greater than or equal to the checksum threshold (1420, NO), the method 1400 includes performing (1440) the external garbage collection to move the valid page data of the victim block in the first memory plane into the external open block in the second memory plane.

In some embodiments, the external open block is included in an external target superblock including one or more memory blocks of the second memory plane.

In some embodiments, the first memory plane and the second memory plane belong to a same memory die.

In some embodiments, the first memory plane and the second memory plane belong to a different memory die.

### Memory System

In another embodiment of the present invention, there is provided a memory device (e.g., NAND module in FIG. 5). The memory device includes a plurality of memory planes including first and second memory planes, each memory plane including a plurality of memory blocks; and a processor including a checksum calculator to calculate checksum on valid page data of at least one victim block in the first memory plane.

The processor is configured to: determine whether at least one target block in the first memory plane is open or full; determine whether the checksum is less than a checksum threshold; and selectively perform one of an internal garbage collection in the first memory plane and an external garbage collection outside the first memory plane, based on the determining whether the target block is open or full and the determining whether the checksum is less than the checksum threshold.

The processor is configured to: when it is determined that the target block is open and the calculated checksum is less than the checksum threshold, perform the internal garbage collection to move the valid page data of the victim block in the first memory plane into the target block in the first memory plane.

In some embodiments, the victim block is included in a victim superblock, the target block is included in an inner target superblock, and each of the victim superblock and the inner target superblock includes one or more memory blocks of the first memory plane.

In some embodiments, the processor receives unit data from a memory controller, splits the unit data to generate multiple data entries corresponding to memory blocks of the victim superblock, and evenly stores the multiple data entries in the memory blocks as the victim block of the victim superblock.

In some embodiments, the valid page data includes the multiple data entries, and the processor performs the internal garbage collection to move the multiple data entries into the target block in the first memory plane.

In some embodiments, the processor is configured to: when it is determined that the target block is full, perform the external garbage collection to move the valid page data of the victim block in the first memory plane into an external open block in the second memory plane.

In some embodiments, the processor is configured to: when it is determined that the target block is open and the calculated checksum is greater than or equal to the checksum threshold, perform the external garbage collection to move the valid page data of the victim block in the first memory plane into the external open block in the second memory plane.

In some embodiments, the external open block is included in an external target superblock including one or more memory blocks of the second memory plane.

In some embodiments, the first memory plane and the second memory plane belong to a same memory die.

In some embodiments, the first memory plane and the second memory plane belong to a different memory die.

Accordingly, the first and second schemes in accordance with embodiments of the present invention can enable the internal garbage collection to reduce transfer traffic between NAND and SoC and power consumption of a memory system.

Although the foregoing embodiments have been described in some detail for purposes of clarity of understanding, the invention is not limited to the details provided. There are many alternative ways of implementing the invention. The disclosed embodiments are illustrative and not restrictive. The present invention is intended to embrace all modifications and alternatives of the disclosed embodiment. Furthermore, the disclosed embodiments may be combined to form additional embodiments.

Indeed, implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple e sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be excised from the combination, and the combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A memory device comprising:
a plurality of memory planes including first and second memory planes, each memory plane including a plurality of memory blocks; and
a processor including a checksum calculator to calculate checksum on valid page data of at least one victim block in the first memory plane,
wherein the processor is configured to:
determine whether at least one target block in the first memory plane is open or full;
determine whether the checksum is less than a checksum threshold; and
selectively perform one of an internal garbage collection in the first memory plane and an external garbage collection outside the first memory plane, based on the determining whether the target block is open or full and the determining whether the checksum is less than the checksum threshold.

2. The memory device of claim 1, wherein the processor is configured to:
when it is determined that the target block is open and that the calculated checksum is less than the checksum threshold, perform the internal garbage collection to move the valid page data of the victim block in the first memory plane into the target block in the first memory plane.

3. The memory device of claim 2, wherein the victim block is included in a victim superblock, and the target block is included in an inner target superblock, and
wherein each of the victim superblock and the inner target superblock includes one or more memory blocks of the first memory plane.

4. The memory device of claim 3, wherein the processor receives unit data from a memory controller, splits the unit data to generate multiple data entries corresponding to memory blocks of the victim superblock, and evenly stores the multiple data entries in the memory blocks as the victim block of the victim superblock.

5. The memory device of claim 4, wherein the valid page data includes the multiple data entries, and
the processor performs the internal garbage collection to move the multiple data entries equally into the target block in the first memory plane.

6. The memory device of claim 1, wherein the processor is configured to:
when it is determined that the target block is full, perform the external garbage collection to move the valid page data of the victim block in the first memory plane into an external open block in the second memory plane.

7. The memory device of claim 6, wherein the processor is configured to:
when it is determined that the target block is open and the calculated checksum is greater than or equal to the checksum threshold,
perform the external garbage collection to move the valid page data of the victim block in the first memory plane into the external open block in the second memory plane.

8. The memory device of claim 7, wherein the external open block is included in an external target superblock including one or more memory blocks of the second memory plane.

9. The memory device of claim 8, wherein the first memory plane and the second memory plane belong to a same memory die.

10. The memory device of claim 8, wherein the first memory plane and the second memory plane belong to a different memory die.

11. A method for operating a memory device, which includes a plurality of memory planes and a processor including a checksum calculator, the method comprising:
determining whether at least one target block in a first memory plane among the plurality of memory planes is open or full;
determining whether checksum on valid page data of at least one victim block calculated by the checksum calculator is less than a checksum threshold; and
selectively performing one of an internal garbage collection in the first memory plane and an external garbage collection outside the first memory plane, based on the determining whether the target block is open or full and the determining whether the checksum is less than the checksum threshold.

12. The method of claim 11, wherein the selectively performing includes:
when it is determined that the target block is open and that the calculated checksum is less than the checksum threshold, performing the internal garbage collection to move the valid page data of the victim block in the first memory plane into the target block in the first memory plane.

13. The method of claim 12, wherein the victim block is included in a victim superblock, and the target block is included in an inner target superblock, and
wherein each of the victim superblock and the inner target superblock includes one or more memory blocks of the first memory plane.

14. The method of claim 13, further comprising:
receiving unit data from a memory controller,
splitting the unit data to generate multiple data entries corresponding to memory blocks of the victim superblock, and
evenly storing the multiple data entries in the memory blocks as the victim block of the victim superblock.

15. The method of claim 14, wherein the valid page data includes the multiple data entries, and
wherein the selectively performing includes:
performing the internal garbage collection to move the multiple data entries equally into the target block in the first memory plane.

16. The method of claim 11, wherein the selectively performing includes:
when it is determined that the target block is full, performing the external garbage collection to move the valid page data of the victim block in the first memory plane into an external open block in the second memory plane.

17. The method of claim 16, wherein the selectively performing includes:
when it is determined that the target block is open and the calculated checksum is greater than or equal to the checksum threshold,
performing the external garbage collection to move the valid page data of the victim block in the first memory plane into the external open block in the second memory plane.

18. The method of claim 17, wherein the external open block is included in an external target superblock including one or more memory blocks of the second memory plane.

19. The method of claim 18, wherein the first memory plane and the second memory plane belong to a same memory die.

20. The method of claim 18, wherein the first memory plane and the second memory plane belong to a different memory die.
